(19) United States
(12) Patent Application Publication
(10) Pub. No.: US 2026/0357673 A1
(43) Pub. Date: Nov. 12, 2026

(54) FLOW MEASUREMENTS USING TEMPERATURE SENSORS

(71) Applicant: Schlumberger Technology Corporation, Sugar Land, TX (US)

(72) Inventors: Yann DUFOUR, Houston, TX (US); Dmitry KORTUKOV, Houston, TX (US); Krishna TRISAL, Houston, TX (US); Cassius Alexander ELSTON, Houston, TX (US); Thomas WAKERLEY, Rio de Janeiro (BR); Eduardo SCUSSIATO, Taubate (BR); Hubert Monthe NGAKAM, Taubate (BR); Tosin Abdul-Kareem, Kuala Lumpur (MY)

(21) Appl. No.: 19/126,261

(22) PCT Filed: Nov. 2, 2023
(86) PCT No.: PCT/US2023/036671

§ 371 Date: May 1, 2025

Related U.S. Application Data
(60) Provisional application No. 63/382,033, filed on Nov. 2, 2022.

(51) Int. Cl. E21B 34/08; E21B 34/02; E21B 43/12; E21B 47/07

(52) U.S. Cl. CPC E21B 34/08; E21B 34/025; E21B 47/07; E21B 43/123

(57) ABSTRACT

Systems and methods using temperature sensor arrays to monitor flow rate and/or composition through valves and nozzles, such as flow control valves, inflow control devices, and/or gas lift valves, are provided. The flow control valves, inflow control devices, and/or gas lift valves will have a choke. The sensor array consists of at least two sensors. At least one of the two sensors is disposed proximate a choke opening. A position or size of the choke opening is configured to be adjusted based on the determined flow rate and/or flow composition based on the measurements from the temperature sensors.

### CROSS-REFERENCE TO RELATED APPLICATION

The present document is based on and claims priority to US Provisional Application Serial No.: 63/382033, filed Nov. 2, 2022, which is incorporated herein by reference in its entirety.

### BACKGROUND

The present disclosure generally relates to valves and nozzles, such as flow control valves, inflow control devices, and/or gas lift valves, including temperature sensors, such as resistance temperature detector sensors, and more particularly, to using data from such sensors to determine flow rate and/or composition through the valve or nozzle.

Oil and gas wells can include one or more downhole flow control valves (FCVs). FCVs can control the flow of fluid (e.g., hydrocarbons) from the exterior of the FCV to the interior of the FCV and into the production tubing string, and/or the flow of fluid (e.g., injection fluid) from the interior of the FCV to the exterior of the FCV. FCVs operate via actuation means such as hydraulic, electric, and/or wireless technologies, or combinations thereof, and may not require mechanical intervention.

Oil and gas wells utilize a borehole drilled into the earth and subsequently completed with equipment to facilitate production of desired fluids from a reservoir. Subterranean fluids, such as oil, gas, and water, are produced from the wellbore. In some cases, the fluid is produced to the surface naturally by downhole formation pressures. However, the fluid must often be artificially lifted from wellbores by the introduction of downhole equipment. Various types of artificial lift are available. In a gas lift system, a compressor is located on the surface. The compressor pumps gas down the casing tubing annulus. The gas is then released into the production tubing via gas valves that are strategically placed throughout the production tubing. The gas that is introduced lightens the hydrostatic weight of the fluid in the production tubing, allowing the reservoir pressure to lift the fluid to surface.

### SUMMARY

In some configurations, a system for use in a well includes a flow control valve and at least two resistance temperature detector sensors coupled to the flow control valve.

Data from the sensors can be used to determine a flow rate and/or flow composition of fluid flowing through the flow control valve. At least one of the sensors can be disposed proximate a choke opening of the flow control valve.

In some configurations, a method includes monitoring resistance of at least two resistance temperature detector sensors coupled to a flow control valve a disposed near a choke opening of the flow control valve; and using the resistance measurements to determine a flow rate of fluid flowing through the choke opening.

The method can include using the determined flow rate to adjust a position or size of the choke opening. Monitoring resistance can include taking measurements at multiple points to detect an array of temperature changes near the choke opening. The method can further include using the resistance measurements to determine a flow composition of the fluid flowing through the choke opening. The determined flow composition can be used to adjust a position or size of the choke opening.

In some configurations, a system for use in a well includes a plurality of flow control valves and at least two resistance temperature detector sensors coupled to each flow control valve of the plurality of flow control valves.

Data from the sensors can be configured to be used to determine flow rate and/or flow composition of fluid flowing through the flow control valve. The position or size of a choke opening of one or more of the flow control valves can be adjusted based on the determined flow rate and/or flow composition.

### BRIEF DESCRIPTION OF THE FIGURES

Certain embodiments, features, aspects, and advantages of the disclosure will hereafter be described with reference to the accompanying drawings, wherein like reference numerals denote like elements. It should be understood that the accompanying figures illustrate the various implementations described herein and are not meant to limit the scope of various technologies described herein.

FIG. 1 shows a partial view of an example FCV including a temperature sensor array.

FIG. 2 schematically illustrates an example system according to the present disclosure.

FIG. 3 shows a partial view of an example FCV including a temperature sensor array.

### DETAILED DESCRIPTION

In the following description, numerous details are set forth to provide an understanding of some embodiments of the present disclosure. It is to be understood that the following disclosure provides many different embodiments, or examples, for implementing different features of various embodiments. Specific examples of components and arrangements are described below to simplify the disclosure. These are, of course, merely examples and are not intended to be limiting. However, it will be understood by those of ordinary skill in the art that the system and/or methodology may be practiced without these details and that numerous variations or modifications from the described embodiments are possible. This description is not to be taken in a limiting sense, but rather made merely for the purpose of describing general principles of the implementations. The scope of the described implementations should be ascertained with reference to the issued claims.

As used herein, the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”; “upper” and “lower”; “top” and “bottom”; and other like terms indicating relative positions to a given point or element are utilized to more clearly describe some elements. Commonly, these terms relate to a reference point at the surface from which drilling operations are initiated as being the top point and the total depth being the lowest point, wherein the well (e.g., wellbore, borehole) is vertical, horizontal or slanted relative to the surface.

Oil and gas wells can include one or more downhole flow control valves (FCVs). FCVs can control the flow of fluid (e.g., hydrocarbons) from the exterior of the FCV to the interior of the FCV and into the production tubing string, and/or the flow of fluid (e.g., injection fluid) from the interior of the FCV to the exterior of the FCV. FCVs operate via actuation means such as hydraulic, electric, and/or wireless technologies, or combinations thereof.

It can be useful for operators to know the flow rate through each flow control valve in use. Such flow rate information can be used to optimize the distribution of flow from multiple zones in the reservoir. For example, if one zone is producing more water, that zone can be choked back to reduce the amount of water produced.

However, measuring multiphase flow through a FCV is difficult. FCVs are deployed kilometers into the ground. Including sensors on a FCV is difficult as the sensors must survive harsh conditions such as high temperature, pressure, flow, and vibration.

The present disclosure provides systems and methods using two or more temperature sensors to derive the flow rate around the valve. Various technologies can be used for temperature measurement, such as thermocouples, thermistors, or RTD (resistance temperature detectors). The resistance of an RTD sensor changes as its temperature changes. The known relationship of resistance vs temperature can therefore be used to detect temperature changes close to the flow control valve. Different fluids such as water, oil, and gas exhibit a different temperature signature due to Joules Thomson effect when passing through the FCV cross section. The composition of the multiphase fluid can be computed by an algorithm based on the resistance and temperature change measured by the sensors, e.g., RTD sensors, close to the FCV. This extra insight can help operators make decisions regarding operation of the well equipment.

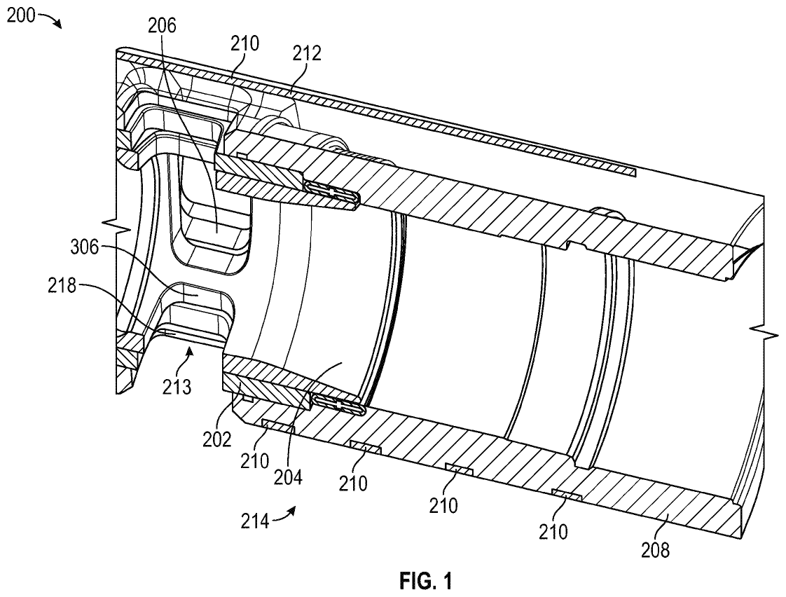

In systems and methods according to the present disclosure, an array of temperature sensors 214, such as RTD sensors, can be embedded in or coupled to a FCV 200, for example as shown in FIG. 1. In some configurations, the FCV 200 can have a continuous choke. As shown in FIG. 1, the choke of the FCV 200 can include a sleeve 202 disposed in a housing 208, and a piston 204 disposed within the sleeve 202. The housing 208 includes an opening 218, and the sleeve 202 includes an opening 206 underlying and/or aligned with the opening 218 of the housing 208. The piston 204 includes an opening 306. The piston 204 is slidable within the sleeve. As the piston 204 is moved relative to the sleeve 202 in use, the percentage of the opening 306 that is aligned with the opening 206 of the sleeve 202 increases or decreases, thereby increasing or decreasing, respectively, the volume of flow through the valve.

A first sensor 210 of the array of temperature sensors 214 can be placed very close to a choke opening 213 of the valve. The first sensor 210 can extend along the flow direction, on one or both sides of the choke depending on the expected flow pattern. The sensor(s) 210 can be packaged individually and/or can be embedded in and/or coupled to a control line 212, as shown in FIG. 1. In use, multiple points of measurement are taken to detect an array of temperature changes near the choke. The array of sensors 214 enables flow rate detection and flow composition detection through correlation with the multiple measurements.

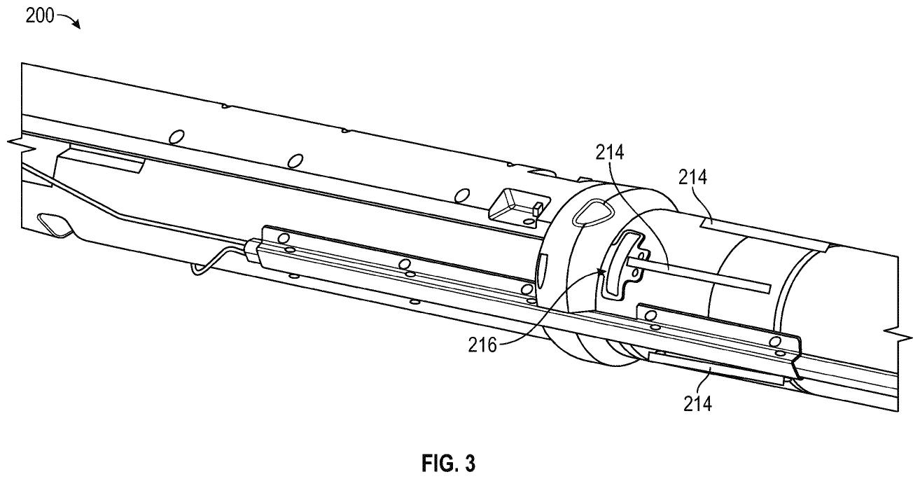

In some configurations, the sensor system can be improved by spatially distributing the array of sensors 214 around each of the cross-sections of the choke 216, for example as shown in FIG. 3. This can improve flow rate measurement in case of horizontal or deviated flow. Such a distribution can allow detection of laminar flow and refine multiphase flow rate determinations in these conditions.

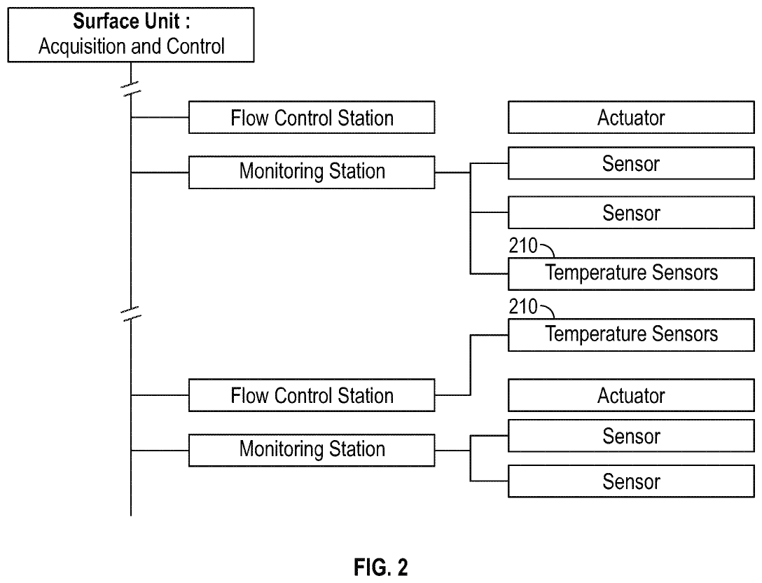

The sensor array(s) 214 can be connected to a dedicated acquisition electronic, which can be part of the FCV 200 or a downhole pressure and temperature gauge, for example as shown schematically in FIG. 2. Depending on the final acquisition configuration, interpretation of data from the sensor array(s) can be performed at various locations, from downhole to a cloud service.

Sensor arrays and methods according to the present disclosure can be used to monitor flow rate and/or flow composition for produced fluid (flowing from outside the FCV to inside the FCV and into the production tubing) or injected fluid (flowing from inside the FCV to outside the FCV). Sensor arrays and methods according to the present disclosure can also be used with ICDs (inflow control devices) to monitor flow rate and/or composition through passive ICDs. Sensor arrays and methods according to the present disclosure can be used with gas lift valves to monitor flow rate and/or composition during gas lift injection operations.

Systems and methods of the present disclosure provide many advantages. Such systems and methods provide the ability to detect flow rate through the flow control valve, which enables operators to make decisions on the position of the choke. Such systems and methods also provide the ability to detect differences in flow phase, which enables operators to detect if gas or water is being produced through the FCV. The temperature measurements, for example from RTD sensors 210, can quantify the water and gas cut from each of the zones being produced. The present disclosure provides a simple and compact sensor design that can advantageously be robustly packaged as part of the FCV or downhole gauge sub assembly deployed with the FCV, for example as shown FIG. 2. The sensors 210 can be connected electrically to an electric FCV station, from which information gathered by the sensors can 210 be communicated to the surface for decision making. Systems and methods according to the present disclosure can allow for automation of flow position based on sensor information. The process to select the optimal choke position of the FCV can be automated based on a software model that runs on an algorithm using the data transmitted from RTD sensors, downhole pressure and temperature gauge measurements, and the FCV choke position. The surface or subsea flow meter data can also be used to further enhance the model.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and/or within less than 0.01% of the stated amount. As another example, in certain embodiments, the terms “generally parallel” and “substantially parallel” or “generally perpendicular” and “substantially perpendicular” refer to a value, amount, or characteristic that departs from exactly parallel or perpendicular, respectively, by less than or equal to 15 degrees, 10 degrees, 5 degrees, 3 degrees, 1 degree, or 0.1 degree.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims. It is also contemplated that various combinations or sub-combinations of the specific features and aspects of the embodiments described may be made and still fall within the scope of the disclosure. It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above.

What is claimed is:

1. A system for use in a well, comprising:
a flow control valve; and
at least two resistance temperature detector sensors coupled to the flow control valve.

2. The system of claim 1, wherein data from the sensors is configured to be used to determine flow rate through the flow control valve.

3. The system of claim 1, wherein data from the sensors is configured to be used to determine a flow composition of flow through the flow control valve.

4. The system of claim 1, wherein at least one sensor of the at least two sensors is disposed proximate a choke opening of the flow control valve. wherein the sleeve can be actuated to a

5. The system of claim 1, wherein the flow control valve comprises:
a sleeve disposed in a housing and a slidable piston disposed within the sleeve;
wherein the housing has an opening aligned with an opening in the sleeve;
wherein the slidable piston has an opening creating a choke.

6. The system of claim 5, wherein the choke has a choke opening that may be adjusted by moving the piston relative to the sleeve thereby changing the percentage of overlap between the piston opening and sleeve opening.

7. The system of claim 6, wherein the at least two resistance temperature detector sensors are considered an array of sensors.

8. The system of claim 7, wherein the flow control valve can have more than one choke opening and an array of sensors are associated with each choke opening.

9. A method comprising:
monitoring resistance of at least two resistance temperature detector sensors coupled to a flow control valve a disposed near a choke opening of the flow control valve; and
using the resistance measurements to determine a flow rate of fluid flowing through the choke opening.

10. The method of claim 5, wherein monitoring resistance comprises taking measurements at multiple points to detect an array of temperature changes near the choke opening.

11. The method of claim 5, further comprising using the resistance measurements to determine a flow composition of the fluid flowing through the choke opening.

12. The method of claim 7, further comprising using the determined flow composition to adjust a position or size of the choke opening.

13. The method of claim 5, further comprising using the determined flow rate to adjust a position or size of the choke opening.

14. A system for use in a well, comprising:
a plurality of flow control valves; and
at least two resistance temperature detector sensors coupled to each flow control valve of the plurality of flow control valves.

15. The system of claim 10, wherein data from the sensors is configured to be used to determine flow rate and/or flow composition of fluid flowing through the flow control valve.

16. The system of claim 11, wherein a position or size of a choke opening of one or more of the flow control valves is configured to be adjusted based on the determined flow rate and/or flow composition.

17. The system of claim 12, wherein the system is configured to adjust the position or size of the choke via automation.

18. The system of claim 12, wherein the flow control valve comprises:
a sleeve disposed in a housing and a slidable piston disposed within the sleeve;
wherein the housing has an opening aligned with an opening in the sleeve;
wherein the slidable piston has an opening creating a choke.

19. The system of claim 18, wherein the choke has a choke opening that may be adjusted by moving the piston relative to the sleeve thereby changing the percentage of overlap between the piston opening and sleeve opening.
